(19) United States
(12) Patent Application Publication
(10) Pub. No.: US 2007/0298208 A1
(43) Pub. Date: Dec. 27, 2007

(54) Process of preparing carpet backing using nonwoven material

(76) Inventor: Lester M. Aseere, Parker, CO (US)

Correspondence Address: JOHNS MANVILLE, 10100 WEST UTE AVENUE, LITTLETON, CO, 80127, US

(21) Appl. No.: 11/475,309

(22) Filed: Jun. 27, 2006

(51) Int. Cl. B32B 33/00; D05C 17/00

(52) U.S. Cl. 428/95; 442/402

(57) ABSTRACT

A process is described for treating a nonwoven fabric to improve its suitability for use as a primary backing in manufacturing tufted carpets and carpet tiles. The process includes the steps of needle-entangling a nonwoven fabric, preferably a spunbonded polyester web, from one or both sides, heat-setting the needled web, calendering and cooling the web and then saturating with a liquid curable elastomeric binder. The saturated web preferably is treated to remove excess binder, heated to dry the web and cure the binder, and wound up on rolls. The resultant fabric is dimensionally stable and has elastomeric properties similar to a woven fabric which provide improved tuft grip and repairability when used as a backing for tufted carpeting.

### BACKGROUND OF THE INVENTION

1. Field of the Invention

The present invention relates generally to a treated nonwoven fabric which has particular utility as a primary backing for carpets. More particularly, the invention relates to a method of treating spunbonded nonwoven polyester fabrics to impart improved characteristics to the fabric when used as a primary backing in manufacturing tufted carpets and carpet tile.

2. Description of the Related Art

A typical backing for broadloom (wall-to-wall) carpeting is a woven polypropylene fabric. Polypropylene fabric is usually satisfactory for carpeting that is firmly attached to the floor as in a typical adhesive or tack strip installation. This fabric does not have to be dimensionally stable since it is attached firmly to the floor and cannot expand, contract or curl.

The same is not true of modern carpet tiles. These tiles usually range from 64 square inches to one square meter or one square yard in size and are designed to be laid in place on a smooth floor without attachment. The tiles are usually composed of different patterns or colors arranged to create an overall pattern or design on the floor. In order for the carpet tiles to remain flat with minimal seam visibility, the tiles cannot expand, contract or curl. For this reason, a nonwoven polyester fabric has been used as a primary backing since polyester fabrics are more dimensionally stable than polypropylene fabrics and thereby provide a better quality finished product.

However, tufting into a nonwoven polyester fabric has proven to be more difficult than tufting into a woven polypropylene fabric. The woven fabric will open within the weave to accept the tufting needle and yarn and then close after the needle retracts leaving the yarn securely held in the opening. The closing property of the woven polypropylene fabric provides a firm grip on the yarn in the opening. The yarn must remain in the opening until adhesive is applied to lock the yarn in place.

Replacing a woven backing with a nonwoven material leads to difficulties. The nonwoven has no weave to open and close nor a memory of the fabric filaments to return to the original state. Tufting into a nonwoven backing usually results in creating an opening large enough to accept the needle and the yarn. However, when the tufting needle retracts, the opening does not close around the yarn but remains larger than necessary to grip the yarn. The result is a condition in which the yarn tufts readily slip out of the opening creating defects and necessitating repair and reworking. A process which overcomes the aforementioned difficulties and provides a polyester nonwoven fabric suitable for use as a backing in the manufacture of tufted carpets would be welcome.

It is an object of the invention to produce a nonwoven fabric having the ability to tightly grip yarns after needle retraction during a tufting operation.

It is another object of the present invention to provide a process for preparing nonwoven fabrics which are useful as backings in the preparation of tufted carpeting and carpet tiles.

These and other objects of the invention will become readily apparent upon a review of the present disclosure

### SUMMARY OF THE INVENTION

In order to remedy the aforementioned difficulties, a method has been developed which includes the steps of needle-entangling a nonwoven fabric on one or both sides, heat-setting the needled fabric, calendering the fabric, applying a curable elastomeric bonding composition, and heating to dry the fabric and complete the cure of the binder.

The treated fabric is then wound up to form rolls.

### DETAILED DESCRIPTION OF THE PREFERRED EMBODIMENTS

Suitable nonwovens to be processed in accordance with the present invention include those prepared from thermoplastic resins including polyolefins, polyamides and polyesters and mixtures thereof. Nonwovens from polyesters are preferred and suitable nonwovens can be prepared by conventional processes including dry-laid, wet-laid, melt blown, spunbonded and spunlaced products.

The nonwoven material most preferred for processing in accordance with the present invention is a spunbonded polyester fabric. As is well known in the art, spunbonding is a process which generally involves feeding a thermoplastic polymer into an extruder, feeding the molten extruded polymer through a spinneret to form continuous filaments, and laying down the continuous filaments on a moving conveyor belt to form a nonwoven web comprising randomly arranged, continuous filament fibers. In the lay-down process, desired orientation may be imparted to the filaments by various means such as rotation of the spinneret, electrical charges, introduction of controlled airstreams, varying the speed of the conveyor belt, etc. The individual, entangled filaments in the nonwoven web are then bonded primarily at filament cross-over points by thermal or chemical treatment before being wound up into a roll form.

The process of the invention initially involves selecting a nonwoven web which preferably has not been thermally bonded and needling the nonwoven fabric in one or preferably both directions through the thickness of the fabric. This needling operation creates fiber entanglement in the “Z” direction (i.e., through the thickness of the fabric) in addition to bonding in the “X” and “Y” direction (i.e., in the machine direction and cross-machine direction). The needling provides fiber bonding and entanglement in all directions, thereby increasing the opportunities for entanglement with the tufted yarn. Needling also provides additional loft to the fabric which results in a slightly thicker material for the same fabric weight and provides an additional grip on the tuft.

Needling (or needle-punching) can be accomplished using any commercially available needle-punching apparatus employing barbed needles. The degree of needling affects the tensile strength of the fabric. The number of needle penetrations per square inch is selected to provide optimum intermingling and entanglement of the individual fibers in all directions.

Custom needling can also be performed. This will create patterns or grain inside the web to provide additional functions.

Alternatives to needle-entangling include the use of hydro-entangling processes that accomplish similar results by employing high pressure water jets rather than barbed needles.

After needling, the fabric is heat-set preferably using a drum oven at about 205° to 210° C. for spunbonded polyester materials. The heat-setting locks in the loft to help in reducing compression upon subsequent calendering of the web and preshrinks the fabric before locking in memory, thereby minimizing additional stretching or shrinking during subsequent processing. Heat-setting also increases dimensional stability. The range of conditions generally suitable for heat-setting will naturally depend upon the polymeric material used to prepare the nonwoven web. Heat-setting may be accomplished, for example, by exposure to pressurized saturated steam or using apparatus which provides dry heat. The range of temperatures for nonwoven polyester fabrics include temperatures of about 190° to about 250° C.

After heat-setting, the fabric is calendered at a temperature and pressure sufficient to bond surface filaments and provide a smooth surface to the fabric. The pressure and temperature can be adjusted to affect the thickness and surface texture of the fabric. Because the fabric was heat-set before calendering, the loft of the fabric remains unchanged and internal fiber entanglement is undisturbed. The range of conditions generally suitable for calendering include a temperature ranging from about 100° C. to about 250° C. and pressures ranging from atmospheric up to about 500 lbs/in². Conventional calender rolls or cylinders can be used in the calendering process.

The fabric is preferably cooled after calendering, preferably to room temperature by air cooling or any conventional cooling means. Cooling is believed to help set dimensional memory in the fabric.

After calendering and cooling, the fabric is saturated by contact with a curable elastomeric binding composition. Preferably, saturation is attained by immersing the fabric in a tank containing the liquid elastomeric binder formulation. The elastomeric binder provides the fabric with the property of allowing the opening made with the tufting needle to shrink in size after the needle retracts. Shrinking of the opening after needle retraction increases the gripping action on the yarn tuft.

Suitable elastomeric formulations include water-based and organic solvent-based elastomers containing conventional curatives and additives. Latexes are preferred for environmental reasons. Examples of suitable elastomers include curable polyurethanes, homopolymers and copolymers of dienes such as butadiene/styrene rubbers, acrylics, etc. Curable elastomeric acrylic latexes are preferred.

The elastic nature of the binder allows for multiple repairs of the fabric if the tuft yarn is removed from the opening for various reasons. In many backing fabrics, the piece of material between needle openings will tear when repairs are necessary. The elastic properties of nonwoven fabrics processed according to the invention allow the piece of material between needle openings to expand and stretch without tearing thereby facilitating repairs.

Preferably, a lubricant is added to the liquid elastomeric binder formulation. The presence of a lubricant allows the tufting needle to be inserted and retracted more easily. The amount of lubricant can be adjusted as needed. Suitable lubricants include silicones, functionalized medium-to-long chain fatty acids, polyglycols and esters thereof. A suitable range of proportions is 0.1 to 10% by weight based on dried-solids content.

Since loft has been locked into the fabric by heat-setting, this allows the fabric to readily absorb the binder formulation and become fully saturated. Also, the amount of binder and the solids content of the formulation can be adjusted for optimum performance. In addition, conventional components can be added to the formulation including colorants, fillers, anti-microbials, water resists, etc.

After saturation with the binder formulation, the fabric preferably is routed through squeeze rollers to remove excess binder material. The wet fabric is then heated to dry the fabric and cure the binder. Preferably, the wet fabric is routed over two drum heaters at a temperature high enough to dry the fabric and cure the binder without softening the polyester fibers or changing the heat-set of the fibers. The curing operation provides additional bonding at filament junctions and elastomeric properties to the fabric. A range of suitable temperatures for nonwoven polyesters for drying/curing is about 100° C. to about 250° C.

The finished product is wound up in rolls. Preferably, winding apparatus is used which is designed to drive the take-up roll at the core. Friction wheel winders may slip on the lubricated surface of the fabric and create poor packing on the roll. Core driven winders will pull the wraps tighter resulting in a much more stable package.

### EXAMPLE

A spunbonded nonwoven polyester fabric having a basis weight of about 100 grams per square meter is needle-punched in at least one direction to create fiber entanglement. The number of needles per square inch is selected to provide optimum properties such as tensile strength. The needled fabric is then heat-set by heating to a temperature of about 200°-210° C. Following heat-setting, the fabric is calendered at a temperature of 150-180 C and pressure of 30 to 70 bar. This may be varied depending upon the overall thickness desired for the final product. After cooling, the fabric is immersed in a tank containing an elastomeric acrylic latex and a wax-based lubricant. The solids content of the elastomer bath is about 17% by weight. The elastomer-saturated fabric is then subjected to a temperature of about 145° C. to dry and cure the binder.

The process of the present invention provides a preferred nonwoven polyester fabric which is eminently suitable as a primary backing for tufted broadloom carpets and carpet tiles. The fabric is dimensionally stable and provides an improved tuft grip. Thus, measurements have shown that up to 20% more force is required to pull the tuft from the backing before additional adhesives are applied to the stitches in another operation. The fabric exhibits improved repairability and, in testing, survived three repairs over the same area without tearing. The loft and softness of the fabric absorbs and deadens tufting machine noise by 3 to 4 decibels. The nonwoven polyester enables needle bars to operate with less drag which requires less force to tuft. Friction temperatures were measured and were 2 to 4° F. less than competitive processes.

Force is measured two ways:

1. Finished fabric is sandwiched between two steel plates with a 30 mm hole in the center. The plates are closed under 100 psi pressure. A tufting needle module of 5 needles is mounted in an Instron device and punctured into the fabric through the opening. Amount of force required to puncture and penetrate is calculated.

2. A 5 needle module is mounted on an actual tufting machine and connected to a strain gauge. A computer plots penetration forces under actual tufting process.

Repairability is measured by a procedure in which a tufting operator removes yarn from a previously tufted backing and attempts to reinsert the yarn into existing holes. The backing needs to hole the yarn after 3 attempts in the same area.

Reduction in tufting machine noise is measured using a decibel meter aimed at the machine needle bar ½ meter away. Measurements are made with “A” weighting and compared to competitive backings on the same machine. Multiple backings are bonded together on the feed side of the machine and noise level differences with each mat are recorded. Noise reduction in the present method comes from mat thickness, softness, and loft, in particular.

The fabric basis and the binder formulation can be adjusted for optimization or for specific applications and requirements. Generally, the solids content of the liquid binder formulation ranges from about 10% to about 30% by weight, preferably about 15% to about 25%.

Having described preferred embodiments of the invention, it is to be understood that the invention is not limited to those precise embodiments, and that various changes and modifications may be effected therein by one skilled in the art without departing from the scope or spirit.

1. A process for treating a nonwoven web which comprises the steps of:
(a) needle-entangling the web in at least the Z direction;
(b) heat-setting the needled web by exposing the web to an elevated temperature sufficient to preshrink fibers in the web and improve dimensional stability;
(c) calendering the web at a temperature and pressure sufficient to provide bonding of surface filaments and a smooth surface;
(d) cooling the treated web;
(e) saturating the web with a liquid, curable, elastomeric binder formulation; and
(f) heating the web at a temperature sufficient to dry the web and cure the binder.

2. The process of claim 1, wherein the nonwoven web is a polyester spunbonded fabric.

3. The process of claim 1, wherein the web is needled in more than one direction.

4. The process of claim 1, wherein the web is heat-set on a drum oven at a temperature of about 205° to 210° C.

5. The process of claim 1, wherein the elastomeric binder comprises an acrylic latex.

6. The process of claim 1, wherein excess binder is removed by passing the web through a set of squeeze rolls.

7. The process of claim 1, wherein drying and curing are accomplished by passing the saturated web over a web of drum heaters.

8. The process of claim 1, wherein the binder formulation includes a lubricant.

9. The process of claim 1, wherein the binder formulation includes conventional adjuvants.

10. The process of claim 1, including the step (h) of winding up the dried, cured web to form rolls.

11. A nonwoven web prepared in accordance with the process of claim 1.

12. A nonwoven polyester web prepared in accordance with the process of claim 2.

13. A tufted carpet or carpet tile including the nonwoven web of claim 11 as a primary backing.

14. A tufted carpet or carpet tile including the nonwoven polyester web of claim 12 as a primary backing.
